(19) United States
(12) Patent Application Publication
(10) Pub. No.: US 2009/0106072 A1
(43) Pub. Date: Apr. 23, 2009

(54) Associating Assets with Agreements

(75) Inventors: Hari K. Gutlapalli, Union City, CA (US); Sridhar Tadepalli, Foster City, CA (US); Arnold C. Espos, Oakland, CA (US); Satheesh Challaveera, Fremont, CA (US); Ajay A. Awatramani, San Francisco, CA (US); Gajanan D. Bhat, Mountain View, CA (US); Kishore Lakshminarayanan, Santa Clara, CA (US)

Correspondence Address: CAMPBELL STEPHENSON LLP, 11401 CENTURY OAKS TERRACE, BLDG. H, SUITE 250, AUSTIN, TX, 78758, US

(73) Assignee: Oracle International Corporation, Redwood Shores, CA (US)

(21) Appl. No.: 12/254,170

(22) Filed: Oct. 20, 2008

Related U.S. Application Data
(60) Provisional application No. 60/981,215, filed on Oct. 19, 2007.

(51) Int. Cl. G06Q 30/00; G06Q 10/00

(52) U.S. Cl. 705/8; 705/28

(57) ABSTRACT

Method and apparatus for associating assets with an agreement, where the assets are typically equipment or machinery and the agreement is typically a service contract. When assets are sold or leased, service is often an important part of the transaction. A user is presented with a sequence of operations in order to streamline the process of creating service agreements to cover assets. The user enters data and proceeds through a flow to associate selected assets with service agreements. The method optionally includes obtaining approval and signatures authorizing the agreement.

This application claims the benefit, under 35 U.S.C. § 119 (e), of U.S. Provisional Application No. 60/981,215, filed Oct. 19, 2007, entitled “Method and System for Associating Assets to Agreements,” and naming Hari K. Gutlapalli, Sridhar Tadepalli, Arnold Espos, Satheesh Challaveera, Ajay Awatramani, Gajanan Bhat, and Kishore Lakshminarayanan as inventors. The above-referenced application is hereby incorporated by reference herein in its entirety.

### FIELD OF THE INVENTION

The present invention relates to creating service agreements, and, more particularly, to associating assets with a service agreement using computers.

### BACKGROUND OF THE INVENTION

There is a significant market for service agreements that provide for repair and maintenance for various types of equipment. Such equipment can range from relatively small, inexpensive items, such as would be used by an individual or family, to larger or more expensive items such as would be used by an organization (e.g., company, university, or government). Such equipment is also referred to as an asset, especially in an organizational setting. The terms of a service agreement dictate what level of service and support a customer, such as an asset owner, operator, or lessee, is entitled to. Service and support, under the terms of a service agreement, can be provided, for example, by an equipment manufacturer, a retailer, or by a third party contracted for the purpose of providing service and support. Service and support can include such things as, for example, repairing or replacing a broken or damaged asset, performing periodic maintenance on an asset, providing technical support to users of an asset, or the like. In order for a service agreement to be meaningful, the agreement must specify what assets the agreement covers.

Personnel (e.g., sales people, call center agents, and field technicians) are often responsible for creating service agreements. The process of creating a service agreement can be a complex and time consuming process including not only agreeing on the terms of the service agreement, but the agreement may also need to be approved by someone with approval authority, and then executed or signed by the customer, e.g., the asset owner or user. This may involve accessing, for example, lists of assets, service plans, charges, and the like. In the past, the process of creating a service agreement was a manual process that would need to be repeated multiple times for multiple assets, relying heavily on personnel experience to avoid inefficiency, duplication, and error. Existing service agreement creation systems continue to rely heavily on personnel experience, requiring personnel to perform a number of operations and access information from a number of sources. For a given asset and agreement, it is often necessary that a user of existing systems, i.e., person responsible for creating a service agreement, have extensive experience with similar service agreements, assets, and business environments. When the user accesses information from a variety of sources, the information is often presented by various means without an intuitive flow for the user to follow. This is particularly burdensome for an inexperienced user. It is therefore desirable to provide a way for less experienced personnel to perform such tasks with a minimum amount of assistance from other personnel having such experience.

### SUMMARY OF THE INVENTION

The present invention streamlines the process of creating service agreements. Associating assets with an agreement, which includes specifying which assets a given agreement covers, is an important part of creating a service agreement. This is a common task for personnel such as sales people, call center agents, and field technicians (also referred to herein as users) who create and sell service agreements. According to one embodiment, a user employs a computer to associate an asset with an agreement. The user is guided through a through a sequence of screens and views where the user can enter multiple records in a way that is simpler, easier, and faster than manually navigating through individual screens relying on the user's existing experience. One advantage of the present invention is to enable a user to quickly and easily associate assets with an agreement. Another advantage to allow relatively inexperienced personnel to perform efficiently with less training and supervision that was required. This not only reduces the cost of creating service agreements for all parties involved, but also increases the speed and accuracy of such tasks.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1 is a block diagram illustrating a network environment in which an asset can be associated with a service agreement according to one embodiment.

FIG. 2 is a block diagram illustrating a computer system that can be used to associate an asset with a service agreement according to one embodiment.

FIG. 3 is a block diagram illustrating submodules of an agreement creation module according to one embodiment.

FIG. 4 is a flowchart showing a high level view of the process of creating a service agreement according to one embodiment.

FIG. 5 is a flowchart showing a detail view of the select agreement operation of FIG. 4 according to one embodiment.

FIG. 6 is an example screenshot showing one view of the select agreement operation of FIG. 5 according to one embodiment.

FIG. 7 is an example screenshot showing one view of the select agreement operation of FIG. 5 according to one embodiment.

FIG. 8 is a flowchart showing a detail view of the select service package operation of FIG. 4 according to one embodiment.

FIG. 9 is an example screenshot showing one view of the select service package operation of FIG. 8 according to one embodiment.

FIG. 10 is an example screenshot showing one view of the select service package operation of FIG. 8 according to one embodiment.

FIG. 11 is an example screenshot showing one view of the select service package operation of FIG. 8 according to one embodiment.

FIG. 12 is an example screenshot showing one view of the select service package operation of FIG. 8 according to one embodiment.

FIG. 13 is a flowchart showing a detail view of the obtain approval operation of FIG. 4 according to one embodiment.

FIG. 14 is an example screenshot showing one view of the obtain approval operation of FIG. 13 according to one embodiment.

FIG. 15 is an example screenshot showing one view of the obtain approval operation of FIG. 13 according to one embodiment.

FIG. 16 is a flowchart showing a detail view of the print for signature operation of FIG. 4 according to one embodiment.

FIG. 17 is an example screenshot showing one view of the obtain signature operation of FIG. 16 according to one embodiment.

FIG. 18 is an example screenshot showing one view of the obtain signature operation of FIG. 16 according to one embodiment.

### DETAILED DESCRIPTION

The following is intended to provide a detailed description of an example of the invention and should not be taken to be limiting of the invention itself. Rather, any number of variations may fall within the scope of the invention which is defined in the claims following the description.

In order to associate an asset with a service agreement according to one embodiment, a number of operations are performed. The operations are performed in a particular sequence. Some operations may be mandatory, and others may be optional. In one embodiment, after receiving input from a user, the next operation in the sequence is automatically determined and presented to the user.

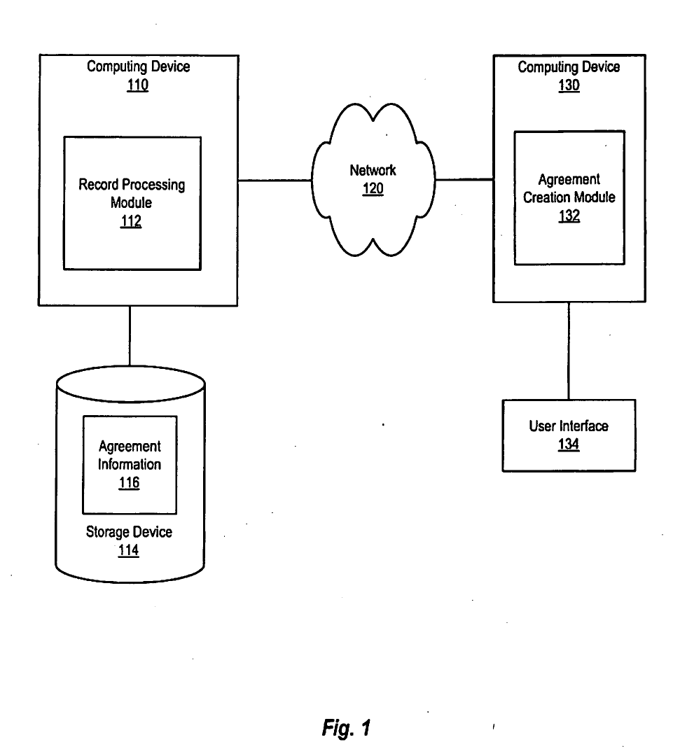

FIG. 1 is a block diagram illustrating a network environment in which a system is implemented for associating assets with service agreements. As shown, the system includes a computing device 110. Computing device 110 implements a record processing module 112. Computing device 110 is shown coupled to a storage device 114. Storage device 114 can be implemented using any storage technology, including hard disks, RAM disks, optical disks, tape or other media and can contain agreement information such as agreement information 116. Computing device 110 is shown coupled to a network 120. Network 120 can include one or more Local Area Networks (LANs) and/or Wide Area Networks (WANs) such as the Internet. Network 120 can be implemented using various wireless links, coaxial cables, fiber optic cables, and the like. A computing device 130 is also coupled to network 120. Computing device 130 implements an agreement creation module 132. Computing device 130 is also shown coupled to a user interface 134, which preferably includes a display screen.

Both computing device 110 and computing device 130 can include one or more servers, personal computers, cell phones, laptop computers, personal digital assistants, or other computing device that is capable of implementing a service agreement creation system in hardware and/or software. It is noted that in alternative embodiments, instead of being implemented on separate computing devices from each other, record processing module 112 and agreement creation module 132 can be implemented on the same computing device.

Computing device 110 implements record processing module 112. Record processing module 112 provides information to agreement creation module 132 and receives and stores information from agreement creation module 132, such as agreement information 116. Agreement information 116 contains completed service agreements as well as information on assets, charge plans, and the like which can be used to construct and modify service agreements. As shown, the system of FIG. 1 includes only one agreement creation module, but it will be understood in light of the present disclosure that more than one agreement creation module can be included in the system of FIG. 1. In the case of multiple agreement creation modules, agreement information 116 can serve as a central repository, providing information to and receiving information from the several agreement creation modules. Consider the example of a customer that purchases a new asset. A field service technician installing the new asset can download to all available service plans for that asset from agreement information 116 to a laptop computer, for example via computing device 110. In this example, the laptop corresponds to computing device 130 of FIG. 1. Then, upon reaching the site where the asset is to be installed, the field service technician can present the customer with alternative available plans. A service agreement can be negotiated by the field service technician and customer, and the negotiated agreement created.

In another embodiment, a call center agent sits at a desk using a computer (e.g., computing device 130), which is linked to a server (e.g., computing device 110). When the agent receives a call concerning a particular asset, the agent accesses agreement information (e.g., agreement information 116) and negotiates a service agreement with the caller. The previous two examples are only two examples of numerous possible embodiments.

Computing device 130 implements agreement creation module 132. Agreement creation module 132 provides functionality which can be used to, for example, create, define, modify, and store service agreements. Agreement creation module 132 can also be used to obtain authorization, display, print, and obtain signatures for service agreements. While FIG. 1 shows agreement creation module 132 being implemented on a single computing device 130, it is noted that the functionality of agreement creation module 132 can be distributed among several such computing devices.

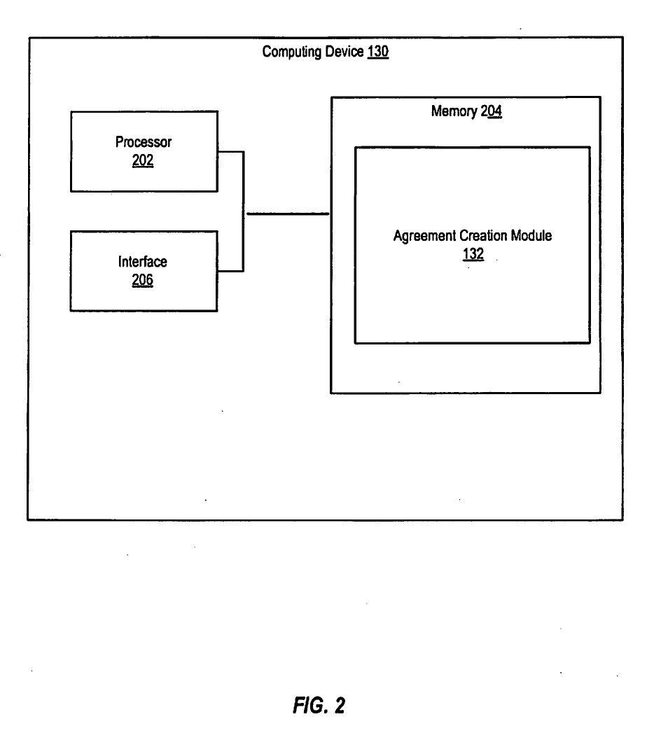

FIG. 2 is a block diagram of a computing device that illustrates how an system that can be used to create agreements, and associate assets therewith, can be implemented in software. The computing device shown in FIG. 2 can be used to implement all or part of an agreement creation module 132. While the illustrated example shows a single module executing on a single computing device, it is noted that in alternative embodiments, the functionality included within agreement creation module 132 can be subdivided among multiple modules, each of which can be implemented on a separate computing device.

Computing device 130 includes one or more processors 202 (e.g., microprocessors, Programmable Logic Devices (PLDs), or Application Specific Integrated Circuits (ASICs)) configured to execute program instructions stored in a memory 204. Memory 204 can include various types of RAM (Random Access Memory), Read Only Memory (ROM), Flash memory, Micro Electro-Mechanical Systems (MEMS) memory, magnetic core memory, and the like. Memory 204 can include both volatile and non-volatile memory. Computing device 130 also includes one or more interfaces 206. A processor 202, an interface 206, and memory 204 are coupled to send and receive data and control signals by a bus or other interconnect.

Interface 206 can include a network interface to various networks and/or interfaces to various peripheral buses. For example, interface 206 can include a network interface via which agreement creation module 132 sends and receives approval requests. Interface 206 can also include an interface to one or more storage devices. For example, agreement creation module 132 can access agreement information (e.g., agreement information 116) stored on such a storage device.

In one embodiment, program instructions and data executable to implement all or part of agreement creation module 132 are stored in memory 204. The program instructions and data implementing agreement creation module 132 can be stored on various computer readable storage media such as memory 204. In some embodiments, such software is stored on a computer readable medium such as a Compact Disc (CD), Digital Versatile Disc (DVD), hard disk, optical disk, tape device, floppy disk, and the like). In order to be executed by processor 202, the instructions and data can be loaded into memory 204 from the other computer readable storage medium. The instructions and/or data can also be transferred to computing device 130 for storage in memory 204 via a network such as the Internet or upon a carrier medium. It is appreciated that operations discussed herein may consist of directly entered commands by a computer system user or by steps executed by application specific hardware modules, but the preferred embodiment includes steps executed by software modules. The functionality of steps referred to herein may correspond to the functionality of modules or portions of modules.

These operations may be modules or portions of modules (e.g., software, firmware or hardware modules). For example, although the described embodiment includes software modules and/or includes manually entered user commands, the various example modules may be application specific hardware modules. The software modules discussed herein may include script, batch or other executable files, or combinations and/or portions of such files. The software modules may include a computer program or subroutines thereof encoded on computer-readable media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described in example embodiment are for illustration only. Operations may be combined or the functionality of the operations may be distributed in additional operations in accordance with the invention.

The software modules described herein may be received by a computer system, for example, from computer readable media. The computer readable media may be permanently, removably or remotely coupled to the computer system. Such computer readable media can include, for example: magnetic storage media including disk and tape storage media; optical storage media such as compact disk media (e.g., CD-ROM, CD-R, etc.) and digital video disk storage media; nonvolatile memory storage memory including semiconductor-based memory units such as FLASH memory, EEPROM, EPROM, ROM or application specific integrated circuits; volatile storage media including registers, buffers or caches, main memory, RAM, and the like; and data transmission media including computer network, point-to-point telecommunication, and carrier wave transmission media. In a UNIX-based embodiment, the software modules may be embodied in a file which may be a device, a terminal, a local or remote file, a socket, a network connection, a signal, or other expedient of communication or state change. Other new and various types of computer-readable media can be used to store and/or transmit the software modules discussed herein.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like. Each of the processes described herein can be executed by a module (e.g., a software module) or a portion of a module or a computer system such as, for example, the computing device shown in FIG. 2.

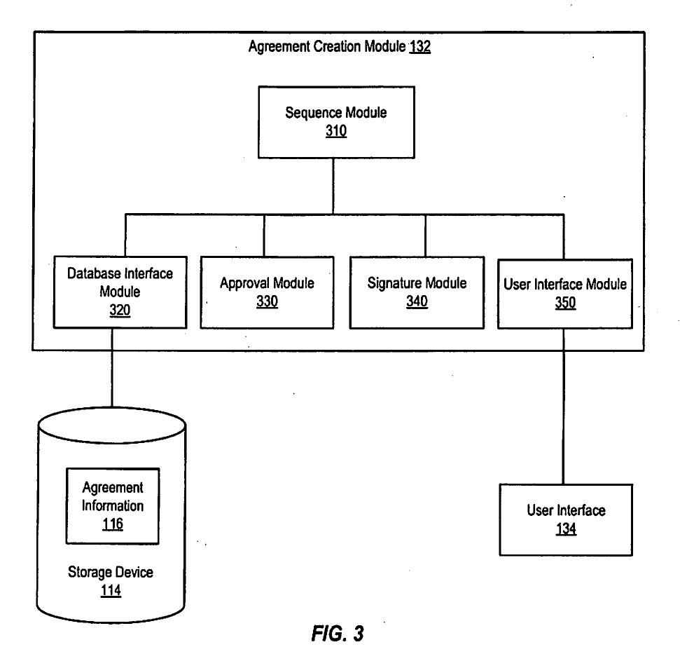

FIG. 3 shows a block diagram of agreement creation module 132, according to one embodiment. In this example, agreement creation module 132 consists of various submodules configured to provide functionality related to associating assets with a service agreement. These submodules include, in one embodiment, a sequence module 310 coupled to a database interface module 320, an approval module 330, a signature module 340, and a user interface module 350. Other embodiments can include additional submodules, or fewer submodules.

Sequence module 310 guides a user through the process of associating an asset with an agreement. The process may have numerous operations requiring numerous sources of information. Sequence module 310 can support a complete process or any portion thereof. The number of operations and which operations are required is determined in part based on user input. Certain operations may be omitted based on user input. Sequence module 310 may also be configured such that certain operations are always required. Sequence module 310 keeps track of which operation the process is currently on. When the process receives user input, sequence module 310 determines, based on the input, the current operation, and the like, the appropriate next operation and advances the process to that operation. Which operation is next may be different if the user input is different, meaning that certain operations will be performed in the creation of some service agreements and not in others, depending on user input. However, the user does not have to make such decisions.

For example, in one embodiment, a user is presented with a screen (e.g., via user interface 134) indicating certain input is required. Using user interface 134, the user can input the required information on the presented screen. User interface module 350 can capture the information and transfer the information to sequence module 310. Sequence module 310 then determines the next step in the process and advances the process. For example, the user can click a button on the screen which indicates the process should be advanced to the next operation. The sequence module performs the processing and determinations discussed above and advances the process. When the process is advanced, the user is presented with a different screen having fields in which to supply information associated with the new operation. In some embodiments, a user can manually control the sequence of operations, thus avoiding one or more automated, guided steps.

The selection of the next operation, for a given present operation and input combination, is configurable. For example, in one embodiment, if a user selects a given input, the result would be a particular next operation in the sequence. However, another embodiment can be configured such that the same input would result in a different next operation in the sequence, resulting in a different overall sequence of operations. Such configuration can be performed, for example, by an administrator or organization deploying the agreement creation system.

For each agreement type that can be created or modified with the system, there can be a distinct sequence. This sequence can be unique to a particular organization, or can change over time, e.g., with changes in the organization's policies. Similarly, the sequence performed with respect to a given asset may require modification. The sequence for each agreement type, or asset, can be modified, for example by adding or removing required operations. Such configuration can be performed, for example, by an administrator.

Agreement creation module 132 also implements database interface module 320. Database interface module 320 is configured to send information to and receive information from storage (e.g., storage device 114). Although FIG. 3 shows database interface module 320 directly coupled to storage device 114, database interface module 320 need not be so coupled. In some embodiments, database interface module 320 sends information to and receives information from storage device 114 via another computing device (e.g., computing device 110 of FIG. 1). Information such as price lists and available service plans, as well as other documents, such as completed service agreements is transferred between database interface module 320 and storage device 114.

As discussed above, agreements can be negotiated by, for example, call center agents or field service technicians. It may not be feasible to complete a service agreement from start to finish in a single round of negotiations. The agreement negotiating process may take place over a period of time. In that case, the details of the ongoing process, such as the current operation of the process, and information input up to that point, can be locally stored (e.g., in computing device 130). Once it is determined (e.g., by sequence module 310) that an agreement is finalized, sequence module 310 can order database interface module 320 to transfer the agreement to more permanent storage, such as storage device 114. Maintaining the data thusly in a partially committed, or transient, state avoids the possibility of data being written (e.g., to storage device 114) prior to completion of the agreement and later inadvertently modified (e.g., overwritten or deleted). Such inadvertent modification could make it impossible to resume and complete the agreement, or lead to errors in the finalized agreement.

Typically, once the details of a service agreement have been negotiated, the next operation in the sequence of creating the service agreement is to obtain approval for the agreement, for example, from management personnel. Accordingly, agreement creation module 132 invokes an approval module 330. Approval module 330 is configured to request and receive approval for a given service agreement. Often, a user negotiating an agreement will not have final approval authority. In that case, approval module 330 automatically determines the authorization that is required. Such a determination can be based on, for example, profile information for the user negotiating the agreement, the total cost of the service plan, and other such criteria. Once the approval module determines the authorization that is needed, the approval module can automatically generate and dispatch requests soliciting that approval. Such requests are typically sent via electronic mail, but other methods can be used (e.g., for example, phone or facsimile). In an alternate embodiment, a user can elect to wait and request approval at a later time.

Generally, in creating a service agreement the customer is required to sign the agreement, or demonstrate a desire to be bound by the agreement in some way. In order to obtain the customer's signature, a signature module 340 is invoked, for example, by sequence module 310. Signature module 340 prepares a finalized version of the negotiated service agreement for presentation to the customer. This includes checking the agreement to see that all required fields are filled, totaling the cost of the agreement, and the like. The agreement can be printed out for the customer's signature, or the customer's signature can be captured electronically by signature module 340. Signature module 340 digitizes the captured signature and associates the digitized signature with the agreement. Signature module 340 is also configured to associate a digital signature with a service agreement. Signature module 340 sends captured signature information to database interface module 320. This information can be included when sequence module 310 instructs database interface module 320 to transfer the completed agreement to storage device 114.

In one embodiment, a user interacts with the system via user interface 134. A user interface module 350 generates user interface 134, and captures information entered by a user of user interface 134. In one embodiment, user interface 134 is presented as a set of web pages having interactive controls. When sequence module 310 determines what operation the process is on, sequence module 310 instructs user interface module 350 to display information related to that operation. For example, user interface module 350 can cause user interface 134 to display a list of possible service plans for a given asset. A user can view and choose a desired plan. The user can input the selection in the form of, for example, clicking a button, selecting items from a drop-down menu, or entering text. User interface module 350 passes the input to the appropriate submodules, for example, sequence module 310. User interface module also causes user interface 134 to present the next set of fields for user input, as determined by sequence module 310.

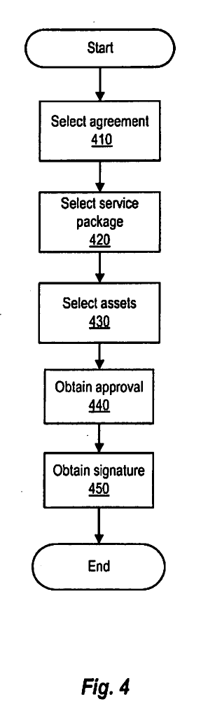

FIG. 4 is a flowchart showing a high level view of creating a service agreement according to one embodiment. The process of FIG. 4 begins with a create agreement operation (operation 410.) Next is a select service package operation (operation 420). The process continues to a select assets operation (operation 430) and an obtain approval operation (operation 440). Finally, an obtain signature operation (operation 450) is performed. These operations are described in greater detail below in the context of a user of the system utilizing a laptop computer (e.g., computing device 130) to negotiate a service agreement with a customer.

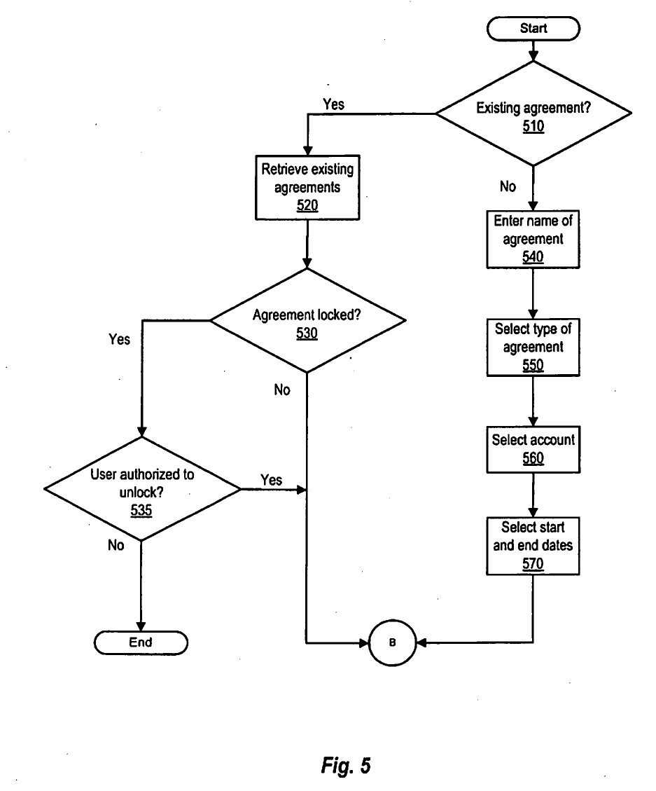

FIG. 5 is a flowchart showing a detail view of the create agreement operation of FIG. 4 (operation 410). The process of FIG. 5 begins with a determination as to whether a user wishes to modify an existing agreement or create a new agreement (operation 510). A user is presented with user interface (e.g., user interface 134, in this case the screen of the user's laptop) which the user can use to choose between modifying an existing agreement and creating a new agreement. When the user inputs a selection (e.g., by selecting a button and clicking “Next”) a user interface module (e.g., user interface module 350 of FIG. 3) captures and transfers the input to a sequence module (e.g., sequence module 310 of FIG. 3). The sequence module determines the next step and updates the user interface module, which causes the user interface to display a new screen.

If a user elects to modify an existing agreement, an agreement creation module (e.g., agreement creation module 132) retrieves and presents a list of existing agreements (operation 520). The list can be retrieved from local storage, such as in the memory of computing device 130. In the alternative, the user can use computing device 130 to access a separate storage device (such as storage device 114 of FIG. 1) which contains agreement information. A user can modify an existing agreement, for example, by adding or removing assets, adding or removing services, changing the level of service or amount charged, and the like. Using the user interface, the user can manually scroll through the list, or the user can employ a query function to perform keyword searches of the existing agreements. After the user selects an agreement, the agreement creation module detects whether the agreement is locked (operation 530). In the case of a locked agreement, unless the user has authority to unlock the agreement, the user is not authorized to modify the agreement and the sequence module determines that the process is at an end. An agreement can be locked to a user, for example, if the user is not authorized to work on a specific account or if the agreement is a high-value agreement (over a certain dollar amount). If the agreement is locked and the agreement creation module determines (at operation 535) that the user has authority to unlock the agreement, the user can unlock the agreement and continue the process. When the selected agreement is not locked, the user is authorized to make changes to the agreement and the process proceeds to the next operation.

If, instead of electing to modify an existing agreement, a user elects to create a new agreement, the sequence module determines that the next step in the process is to enter a name for the agreement (operation 540). The sequence module causes the user interface to display a prompt for the user to enter a name. The name entered can be a client's name, an address, a descriptive nickname, or any other textual identifier. Preferably, the name entered is one that uniquely identifies the agreement, so that the agreement can be readily located, for example, using a keyword search. The process then proceeds to operation 550, where the user selects the type of agreement to create. For example, a user can select a service contract, or a maintenance requisition.

Next is a select account operation (operation 560). In one embodiment, an organization having several assets will require several different agreements with a service provider to cover the assets. Each of the agreements can be paid for by different departments within the organization. Each separate paying department will have an account with the service provider. Being able to select the account can also allow the user to see what other agreements are associated with the account. This can be useful in creating further agreements. The user selects the account the new agreement will be associated with.

The user interface also provides the user the opportunity to enter the start and end dates (operation 570). For example, if the agreement covers scheduled maintenance for the period of a year, the date the coverage begins is the start date and the date the coverage is scheduled to end (a year later) is the end date. Or if the agreement covers a single service which is to be completed in one day, the start and end date will be the same, i.e., the day the service is scheduled.

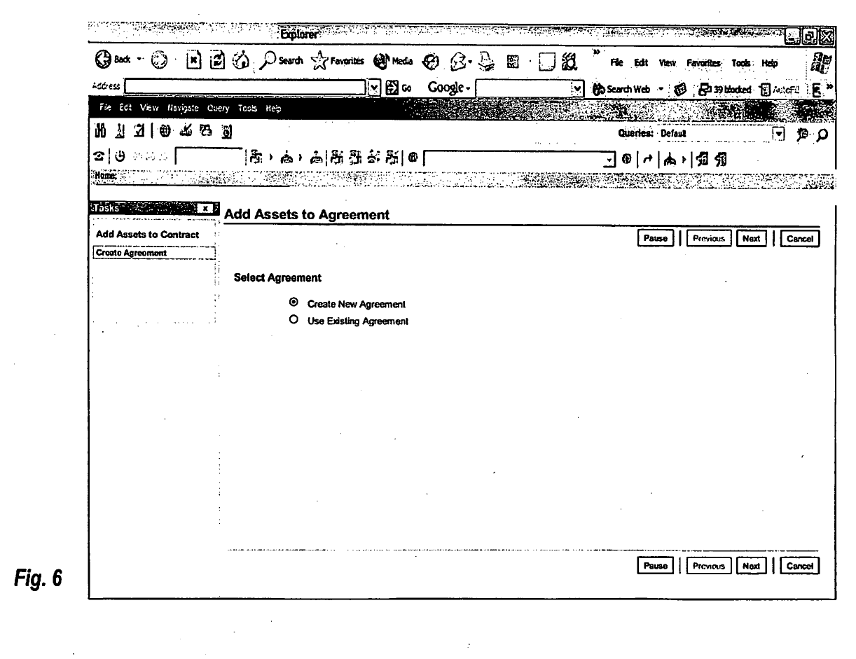

FIG. 6 is a screenshot showing one view of the create agreement operation detailed in FIG. 5. A user has the option to modify an existing agreement or create a new agreement. FIG. 6 also shows buttons which can be activated to proceed to the next operation in the sequence, return to the previous operation, pause the process, or cancel the process. If the user clicks next, the sequence module automatically determines, based on whether the user has selected create new agreement or use existing agreement, what the next operation in the process is to be. The sequence module can make such determinations at every operation of the process, thus guiding a user from one operation to the next in a logical progression. In another embodiment, a user can manually select the next operation in the sequence, thus overriding the determinations made by the sequence module.

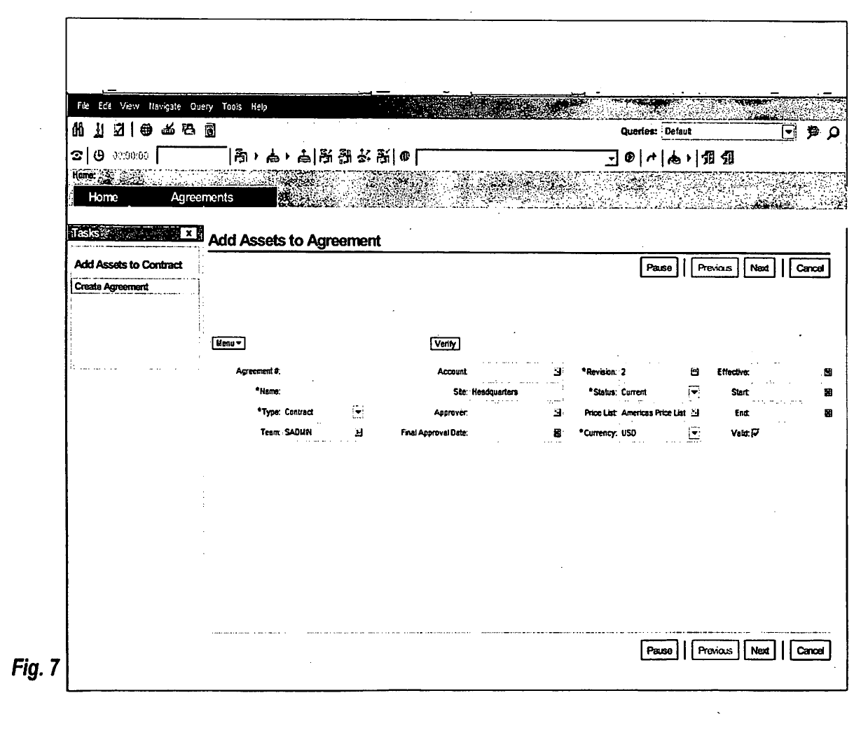

FIG. 7, a screenshot showing one view of the create agreement operation of FIG. 5, shows several means of entering data related to a service agreement. A user can enter data, for example, by selecting from drop down menus and can manually enter data. Based on the user's input, the sequence module determines the next operation in the process. As noted, the user can manually override the determination if necessary.

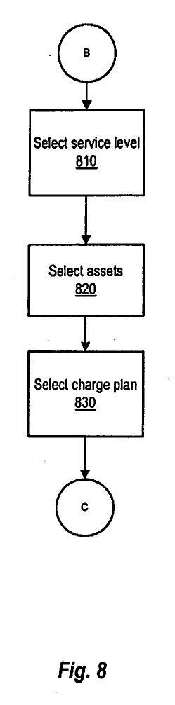

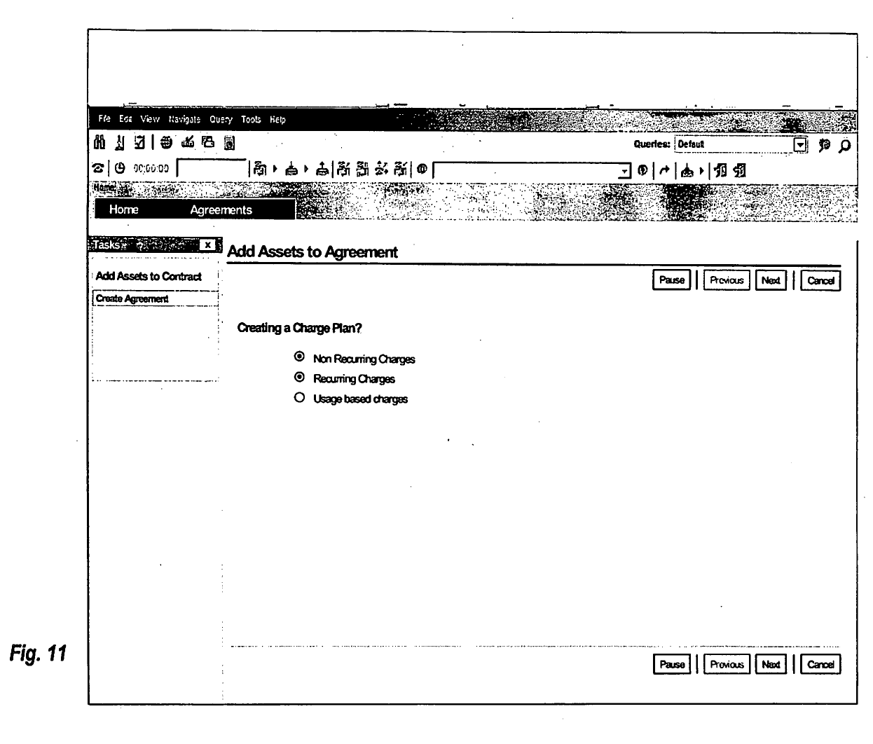

FIG. 8 is a flowchart showing a detail view of the select service package operation of FIG. 4 (operation 420). The process of FIG. 8 begins with a select service level operation (operation 810), in which a user can select a service level using the user interface. Different assets have different service needs. For example, a business can require high availability of a given asset. In that case, the business will require on-site service, rather than shipping the asset to a repair facility, which generally takes a longer time. Another businesses may only require service coverage for an asset during normal business hours. Or, the business may require 24 hour a day, 7 days a week coverage for the asset. Based on such factors, a user can select a service level which best suits a customer. After entering the service level via the user interface, one or more assets to be covered are selected (operation 820). The user can select assets from a list presented via the user interface, or can manually enter an asset in spaces provided by the user interface. Finally, a charge plan is selected (operation 830) as is discussed with respect to FIG. 11.

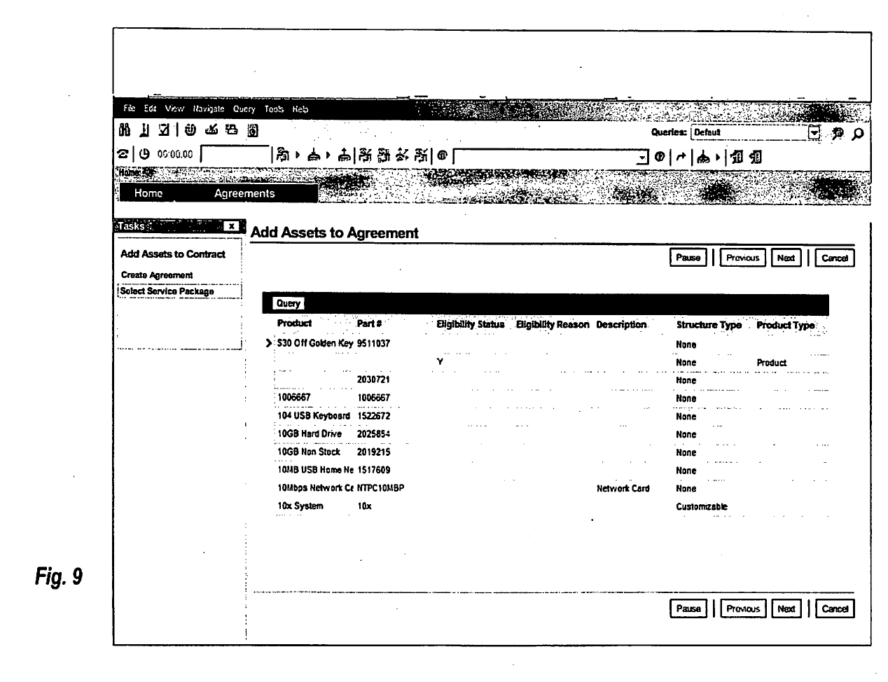

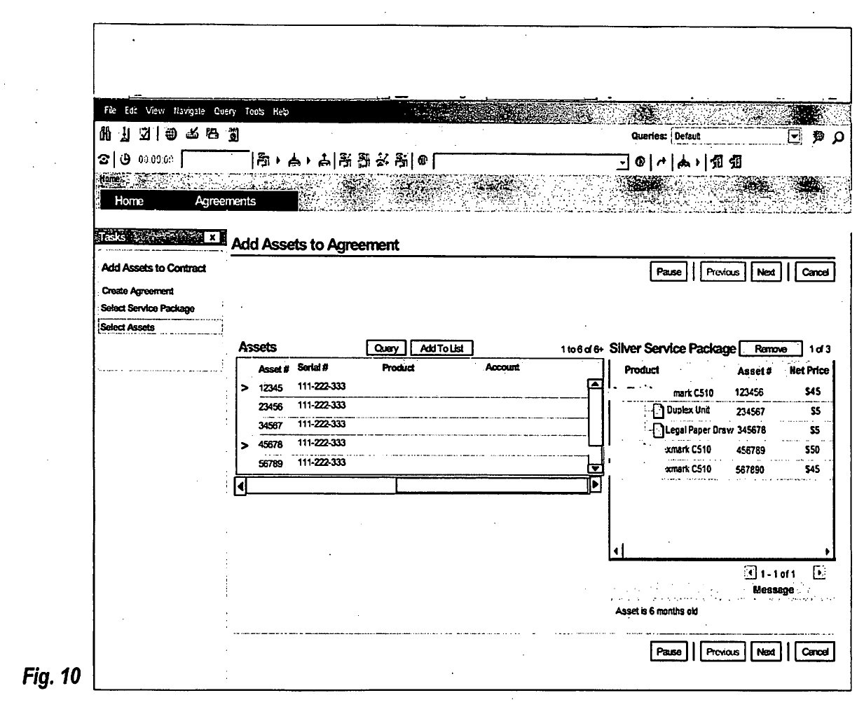

FIG. 9 is an example screenshot showing one view of the select service package operation of FIG. 8. FIG. 9 shows a searchable list of service products. A user can search the list using a keyword search, or can manually search through the list to find a list which satisfies a given customer's requirements. The sequence module determines which items to display next based on the service package selected. In operation 820, the agreement creation module presents details concerning specific assets, including serial number, cost to service, and descriptions of the assets, as is shown in FIG. 10. The assets selected are to be included in the service agreement.

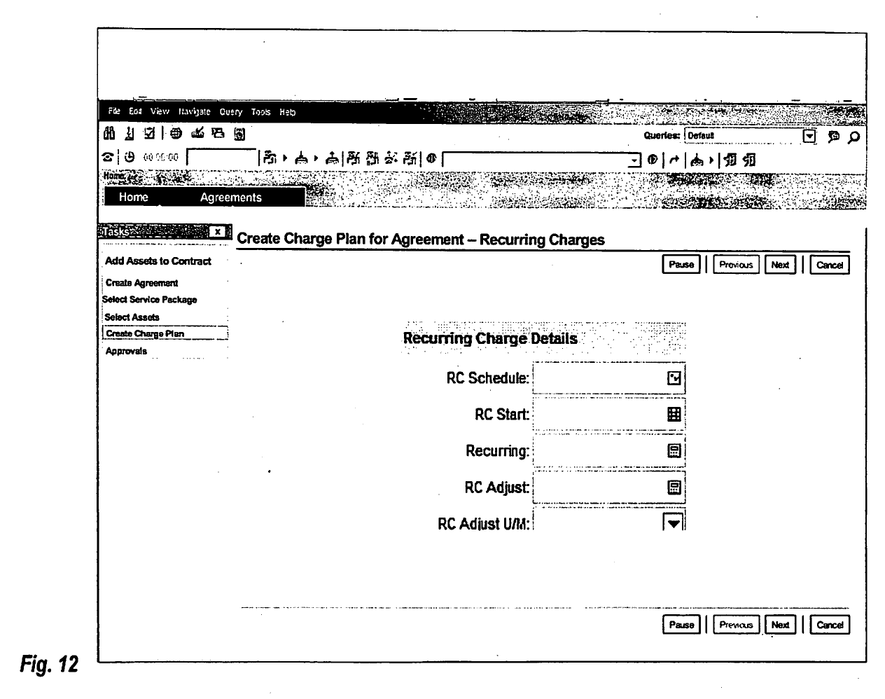

FIGS. 11 and 12 are example screenshots showing views associated with the select charge plan operation of FIG. 8 (operation 830). As can be seen, a user interface is presented which allows a user to select whether the charges due for a particular service agreement are recurring, non-recurring, or usage based charges. For example, if an organization selects a service agreement to cover an asset for one year, the organization may wish to pay for the coverage in periodic installments. For example, if the asset is to be serviced four times during the year, the organization can select a recurring charge and specify that the charges are to accrue when the asset is serviced. Or, an organization may not know how much service will be required for an asset. In that case the organization can select a usage based plan which allows the organization to receive more or less service and pay only for the service actually received. The sequence module directs the user interface to display the next information based on what the user selects. In the case where a user selects recurring charges, the next screen will display information used to set up the recurring charges, such as frequency of occurrence, start and end date, and the like. The charge plans discussed above are merely examples of charge plans. Other charge plans and types of charge plans can be implemented.

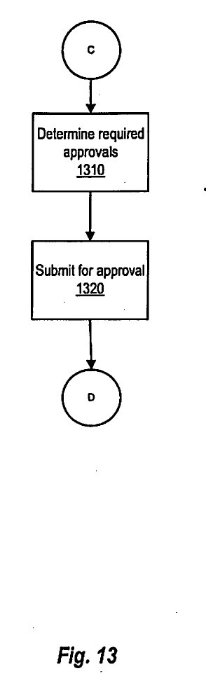

FIG. 13 is a flowchart showing a detail view of the obtain approval operation of FIG. 4 (operation 430). Once a user has negotiated a service agreement with a client, the user frequently will need to seek approval, for example, from a supervisor. The approval module determines which approvals are required (operation 1310). For example, agreements for certain organizations, or above certain dollar amounts, may require approval from managers or technical personnel above a certain level.

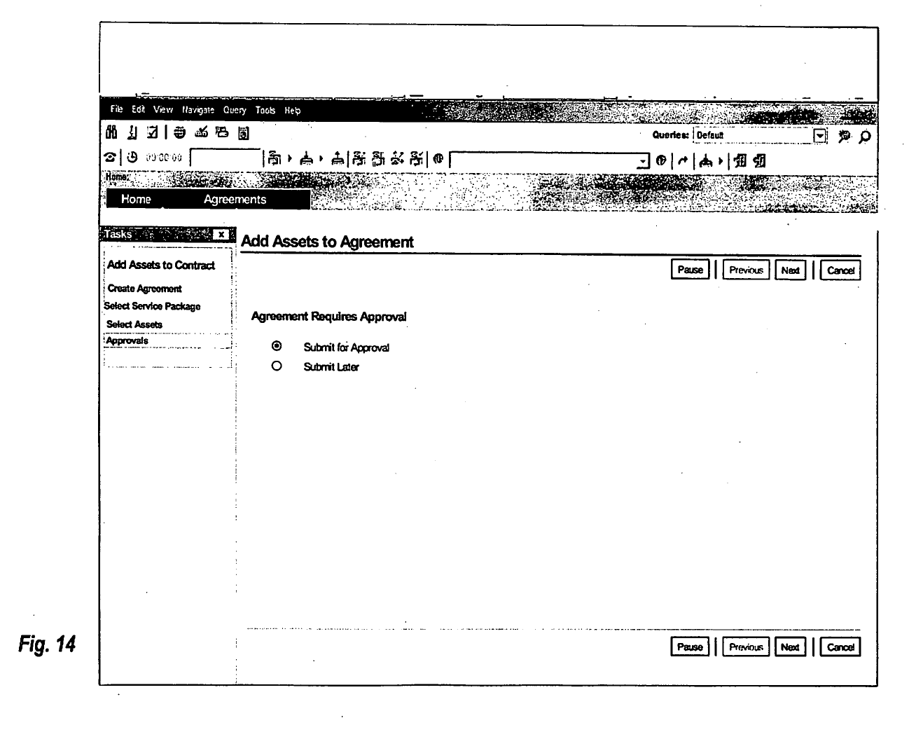

As seen in FIG. 14, the sequence module presents (via the user interface) a step giving the user an opportunity to submit the negotiated service agreement for approval (operation 1320) or to submit the updated service agreement for approval later. When the user elects to submit an agreement for approval, the approval module is notified. The approval module will then send an electronic notification, for example, an email, alerting the person whose approval is required that there is a pending service agreement for approval. The notification can be delivered by email, phone, messenger, or by any other method. The notification can include the service agreement, or can indicate where the agreement is stored and direct the approver to that location (e.g., a link to a file on a server).

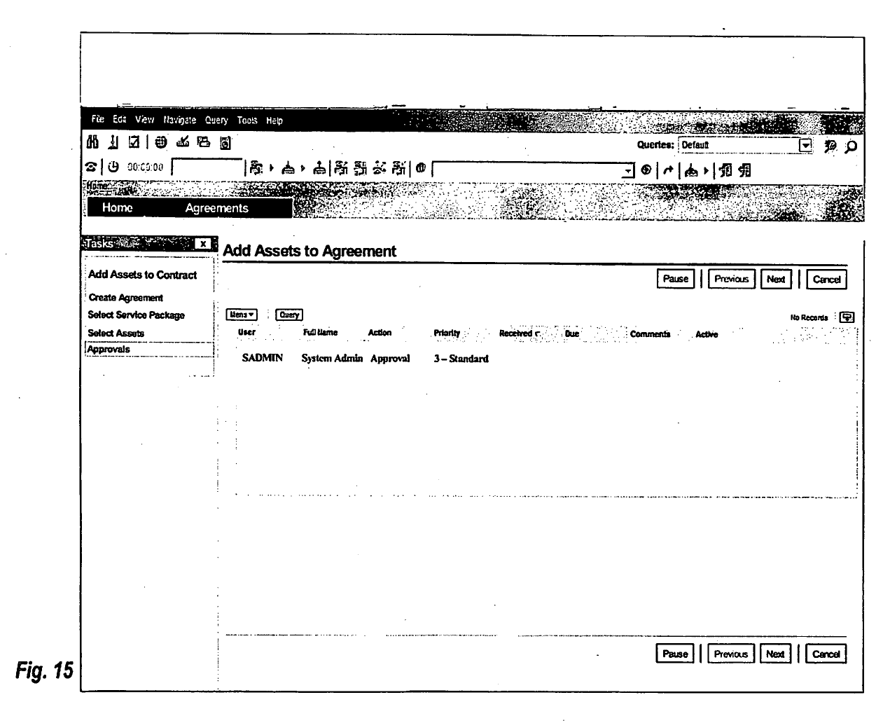

FIG. 15 is an example screenshot showing one view of the user interface presented as part of the submit for approval operation of FIG. 13 (operation 1320). FIG. 13 shows the required approvals. In the example shown, the approval module has determined that approval is required from user SADMIN, and sent that information to the user interface. Priority for the approval of the service agreement is also indicated.

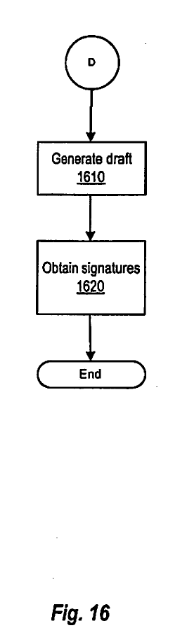

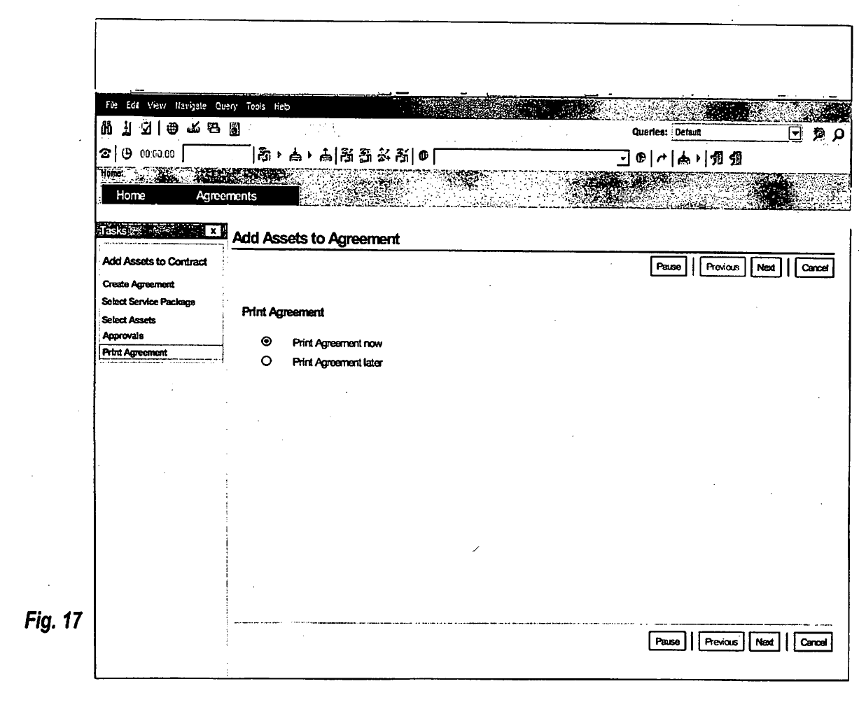

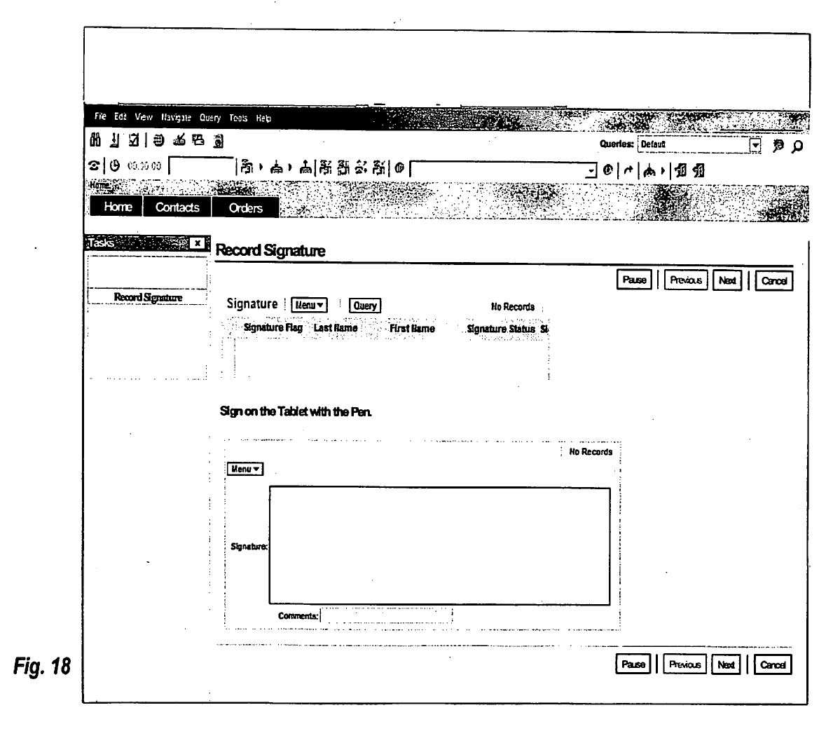

FIG. 16 is a flowchart showing a detail view of the obtain signature operation of FIG. 4 (operation 440). The process of FIG. 16 begins with a generate draft operation (operation 1610). A signature module (such as signature module 340 shown in FIG. 3) generates a draft agreement. The draft can include some or all of the information specified by the user during the agreement creation process. Via the user interface, the signature module gives a user an opportunity to print the agreement (shown in FIG. 17). In the alternative, a user can capture a client's signature digitally, for example on a tablet PC (as shown in FIG. 18). The system also allows a client to digitally sign the agreement.

The flowcharts provided here are provided as examples. It is noted that other embodiments can include different operations instead of and/or in addition to those shown in the flowcharts presented herein. Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer implemented method comprising:
associating an asset with a service agreement, wherein
the associating comprises a plurality of actions, and the actions of the plurality of actions are organized into a sequence;
automatically presenting an action of the plurality of actions;
receiving entered data;
automatically selecting a next action of the plurality of actions, in response to the entered data; and
automatically presenting the next action.

2. The computer implemented method of claim 1 wherein
the plurality of actions is customizable by a customer.

3. The computer implemented method of claim 1 further comprising:
storing entered data in a local storage unit; and
storing the entered data in a database, in response to detecting an asset is associated with the service agreement.

4. The computer implemented method of claim 3 further comprising:
modifying the entered data after the entered data is stored in local storage.

5. The computer implemented method of claim 1 wherein the plurality of actions comprises:
selecting a service agreement;
selecting a service package;
selecting the asset;
obtaining authorization; and
displaying the service agreement.

6. The computer implemented method of claim 5 wherein the selecting a service agreement further comprises:
creating a new service agreement.

7. The computer implemented method of claim 5 wherein the selecting a service package comprises:
selecting a level of service and selecting a charge plan.

8. The computer implemented method of claim 5 wherein the displaying further comprises:
capturing a signature of a client.

9. The computer implemented method of claim 1 further comprising:
providing a plurality of sequences to a customer, wherein
each sequence comprises a plurality of actions, and
each sequence comprises associating an asset with a service agreement.

10. A computer readable storage medium storing instructions, wherein a method is implemented when the instructions are executed, the method comprising:
associating an asset with a service agreement, wherein
the associating comprises a plurality of actions, and
the actions of the plurality of actions are organized into a sequence;
automatically presenting an action of the plurality of actions;
receiving entered data;
automatically selecting a next action of the plurality of actions, in response to the entered data; and
automatically presenting the next action.

11. The computer readable storage medium of claim 10, wherein the plurality of actions is customizable by a customer.

12. The computer readable storage medium of claim 10, wherein the method further comprises:
storing entered data in a local storage unit; and
storing the entered data in a database, in response to detecting an asset is associated with the service agreement.

13. The computer readable storage medium of claim 12, wherein the method further comprises:
modifying the entered data after the entered data is stored in local storage.

14. The computer readable storage medium of claim 10 wherein the plurality of actions comprises:
selecting a service agreement;
selecting a service package;
selecting the asset;
obtaining authorization; and
displaying the service agreement.

15. The computer readable storage medium of claim 14 wherein the selecting a service agreement further comprises:
creating a new service agreement.

16. The computer readable storage medium of claim 14 wherein the selecting a service package comprises selecting a level of service and selecting a charge plan.

17. The computer readable storage medium of claim 14 wherein the displaying further comprises:
capturing a signature of a client.

18. The computer readable storage medium of claim 10, wherein the method further comprises:
providing a plurality of sequences to a customer, wherein
each sequence comprises a plurality of actions, and each sequence comprises associating an asset with a service agreement.

19. An apparatus comprising:
a memory system storing a database;
a computer system comprising a memory, wherein the memory stores instructions, wherein the computer system implements a method in response to executing the instructions, the method comprising:
associating an asset with a service agreement, wherein
the associating comprises a plurality of actions, and the actions of the plurality of actions are organized into a sequence;
automatically presenting an action of the plurality of actions;
receiving entered data;
automatically selecting a next action of the plurality of actions, in response to the entered data; and
automatically presenting the next action.

20. An apparatus comprising:
means for associating an asset with a service agreement, wherein
the means for associating is configured to present a plurality of actions, and the actions of the plurality of actions are organized into a sequence;
means for automatically presenting an action of the plurality of actions;
means for receiving entered data;
means for automatically selecting a next action of the plurality of actions, in response to the entered data.
